(19) United States
(12) Patent Application Publication
(10) Pub. No.: US 2006/0075305 A1
(43) Pub. Date: Apr. 6, 2006

(54) Method and system for source-code model-based testing

(75) Inventors: Henry J. Robinson, Snohomish, WA (US); Michael P. Corning, Woodinville, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 10/957,132

(22) Filed: Oct. 1, 2004

(51) Int. Cl. G06F 11/00

(52) U.S. Cl. 714/38

(57) ABSTRACT

Disclosed is a method for using source code to create the models used in model-based testing. After exploring the intended behavior of a software package, a test engineer writes source code to model that intended behavior. The source code is compiled into a model, and the model is automatically analyzed to generate numerous test scripts that can exercise the behavior of the software package. When the tests are run, their results are compared against intended behaviors, and discrepancies are used to correct the software package (or to correct the source-code model if it was prepared incorrectly). The model coding, test generation, test execution, and comparison steps are repeated as often as necessary to thoroughly test the software package. In some embodiments, the test scripts generated by the model are written in XML (Extensible Markup Language), allowing the easy integration of the test scripts with a number of XML-based tools.

### TECHNICAL FIELD

The present invention is related generally to software testing, and, more particularly, to model-based testing using computer source code to create the model.

### BACKGROUND OF THE INVENTION

Well known and well dreaded today are the costs of testing software packages. (In this description, “package” means any software to be tested. A software package can be a traditional user application, a utility provided by an operating system, a library of useful functions, an internal method not visible to any user, etc.) Software testing costs are skyrocketing in part due to the increased complexity of software offerings, in part due to heightened expectations of software consumers, in part due to increasing levels of interconnectivity among applications, and in part due to the increased number of software vendors whose products should, at the very least, exist amicably with one another. In some cases, the costs of thorough testing can approach or even exceed the costs of developing the software in the first place.

Testing costs are not a new phenomenon nor are approaches intended to control those costs. Long past is the era when testing consisted mainly of a test engineer sitting at a keyboard and “exercising” a software package by entering commands and seeing if what happened was what should have happened. It is much more efficient for the test engineer to write “test cases” that are then run by a computer to exercise the software. This automated testing more thoroughly and quickly tests the software than could any single test engineer. However, these test cases tend to be written to catch known bugs rather than to find new ones, and they are expensive to create and more expensive to keep up-to-date as the software package changes with each new release.

A relatively recent approach, by no means universal as yet, to the problem of the costs of writing and maintaining test cases is called “model-based testing.” Here, another level of indirection is taken: Instead of writing test cases directly, the test engineer creates a “model” of the software package to be tested. For example, the software package is modeled as a constellation of “states” with well defined transitions moving the software from one state to another. In model-based testing, the test engineer creates in a model a representation of those states and of the allowed transitions between the states. A computer then takes this model as input and from it generates numerous test cases. The test cases are run as before to exercise the software package. As can be easily appreciated, a computer can quickly generate many more test cases from the model than a test engineer would ever have time to draft by hand. The computer is also less likely to focus the test cases solely on known bugs or to ignore obscure aspects of the software package's functionality. Thus, model-based testing more thoroughly “covers” the range of situations possible for the software package and is remarkably efficient at uncovering obscure bugs that only arise in unlikely situations.

A real glory of model-based testing is shown when the software package changes (either to incorporate new features or to address bugs found in previous testing). In this case, rather than updating an enormous set of test cases, the test engineer simply updates the model and then automatically generates a new set of test cases. Because the model is so closely tied to the functionality of the software package, the model can be kept up-to-date as the package changes much more readily than can a static set of test cases.

Generating a model of a software package to be tested is a sophisticated exercise even for a test engineer who thoroughly understands the intended behavior of the software. To help test engineers in creating their models, powerful model-creation tools have been developed. These tools present a trade-off, however: Their powerful framework provides wonderful results quickly but restricts the ability of test engineers to express features or functions that they wish to test. As the field of test development begins to attract ever more highly trained engineers, this lack of sufficient expressiveness is becoming a serious hindrance to the full flowering of model-based testing. One approach to this problem is the development of more powerful but flexible model-creation tools, but the released tools always lag behind the needs of the more innovative test engineers.

### SUMMARY OF THE INVENTION

In view of the foregoing, the present invention provides a method for using source code to create the models used in model-based testing. After exploring the intended behavior of a software package, a test engineer writes source code to model that intended behavior. The source code is compiled into a model, and the model is automatically analyzed to generate numerous test cases that can exercise the behavior of the software package. When the tests are run, their results are compared against intended behaviors, and discrepancies are used to correct the software package (or to correct the source-code model if it was prepared incorrectly). The model coding, test generation, test execution, and comparison steps are repeated as often as necessary to thoroughly test the software package.

Basing model development on source code written by a test engineer gives the engineer a heightened level of flexibility in responding to found bugs and in directing the testing toward specific aspects of the software package. The flexibility of the source-code model also allows an engineer to code up a new test technique as soon as he thinks of it rather than waiting, as is traditional, for developers of model-creation tools to include the new technique in a future release. While a test engineer who develops models in source code gives up some of the ease of use of the model-creation tools, that engineer will usually find that added flexibility and speed more than outweigh any loss.

Flexibility is also enhanced on the “output” side of the modeling process. In some embodiments, the test cases generated by the model are written in XML (Extensible Markup Language). Using this ever more popular language allows the easy integration of the test cases with a number of XML-based tools, either already existing or contemplated.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a workflow diagram generally showing how a software package is subjected to source-code model-based testing;

FIG. 2 is a block diagram showing an exemplary computing environment with numerous computing devices simultaneously testing a software package;

FIG. 3 is a schematic diagram generally illustrating an exemplary computing device that supports the present invention;

FIG. 4 is a block diagram illustrating various model-based testing technologies and how they relate to one another;

FIG. 5 is a screen capture showing states produced by a model according to the present invention; and

FIG. 6 is a block diagram illustrating the major components of an exemplary test-execution system.

### DETAILED DESCRIPTION OF THE INVENTION

Turning to the drawings, wherein like reference numerals refer to like elements, the present invention is illustrated as being implemented in a suitable computing environment. The following description is based on embodiments of the invention and should not be taken as limiting the invention with regard to alternative embodiments that are not explicitly described herein.

In the description that follows, the environment surrounding the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

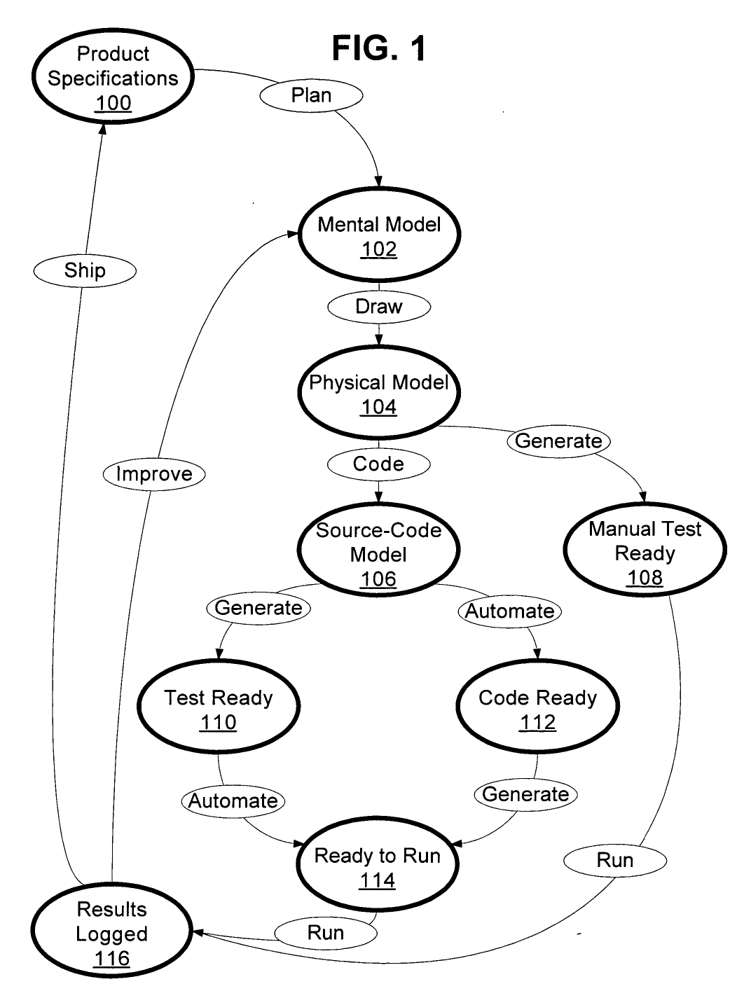

FIG. 1 shows how the techniques of model-based testing can be used to go from a mental model of a software package to be tested to a log of results from tests executed against that software package.

Starting with a technical description 100 of the software package, a test engineer prepares a basic mental model 102 of how the software is supposed to behave. Often, but not always, the test engineer already has a running version of the software and can also explore that in order to enhance his mental model 102. Next, the test engineer articulates this mental model 102 into a physical model 104, which may be a simple paper sketch. By articulating, the test engineer helps himself to see aspects of the software's intended behavior that he does not fully understand. Also, the physical model 104 can be reviewed by other test engineers. Now following the traditional path from the physical model 104, the test engineer drafts test cases 108 based on the physical model 104 and runs those test cases against the software package. Discrepancies in the results 116 are used by the test engineer to improve the mental 102 and physical 104 models.

Of course, there is a limit to how far this manual test process can be taken. According to the present invention, the test engineer uses the physical model 104 to write a source-code model 106 of the software package to be tested. In an embodiment of the invention, a tester extracts states, guards, and transitions from the specification 100 and codes them into the source-code model 106. The source-code model 106 can then be used in various ways, depending upon the particular needs of the test engineer. A program can be invoked that generates a “random walk” through the state space of the source-code model 106 to test it (as is explained in greater detail below) or a finite state model can be generated and test cases automatically written to traverse the finite state model's state graph (also explained below). In any case, a test automation program runs the tests and records the results 116, comparing the results to the software package's intended behavior. As in the case of manually written test cases, the iterative process of modeling (102, 104, 106), generating test cases (108, 110, 112, 114), and running the tests against the software package (116) continuously improves the finished product (and the models 102, 104, and 106: bugs may be found there as well as in the software package itself). Once the last test passes, the software package is shipped to customers, and the cycle begins again with the specifications 100 of the next version of the software package.

It is worth noting how far a test engineer can proceed through FIG. 1 workflow before there is a working version of the software package to test. The description 100 of the intended behavior of the software package, coming from the minds of customers, designers, and testers, is enough to use as input to the modeling process. The models 102, 104, and 106 model intended behavior, while only the later generated test cases test the software package itself. The intended behavior of any software package should be understood before implementation begins, so test engineers should be involved in the product cycle even before developers are.

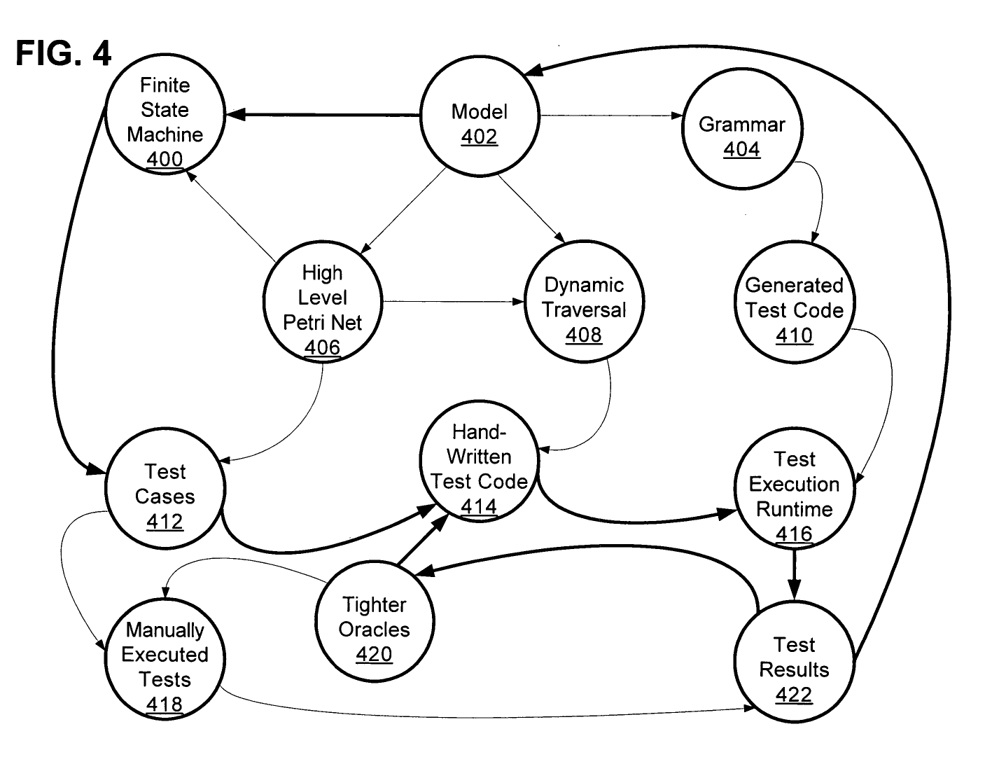

Another point to be noted is that FIG. 1, which is only an example and is not meant to be inclusive, mentions drawing a state graph, but state machines are only one, albeit the most popular, way of modeling software. Other model types, such as grammars, produce behavior that can be specified through rules embodied in a model. The text accompanying FIG. 4 shows some of these other model-based testing technologies. Various embodiments of the present invention support all of the technologies shown in FIG. 4.

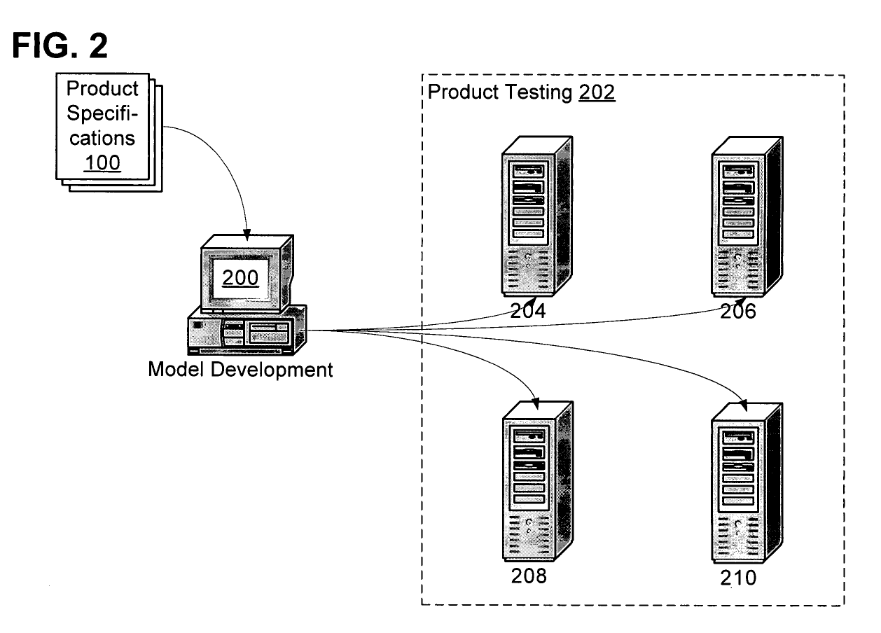

Before describing embodiments of the present invention in greater detail, FIG. 2 shows a typical model-based testing environment. The specifications 100 of the software package to be tested are used as input to a model development process 200. Once the modeling process is complete, the test cases generated are sent to product testing 202 where they are run, often in parallel, on testing machines 204, 206, 208, and 210. As results are generated by the testing machines, they are fed back to improve the specifications 100 and the model development process 200.

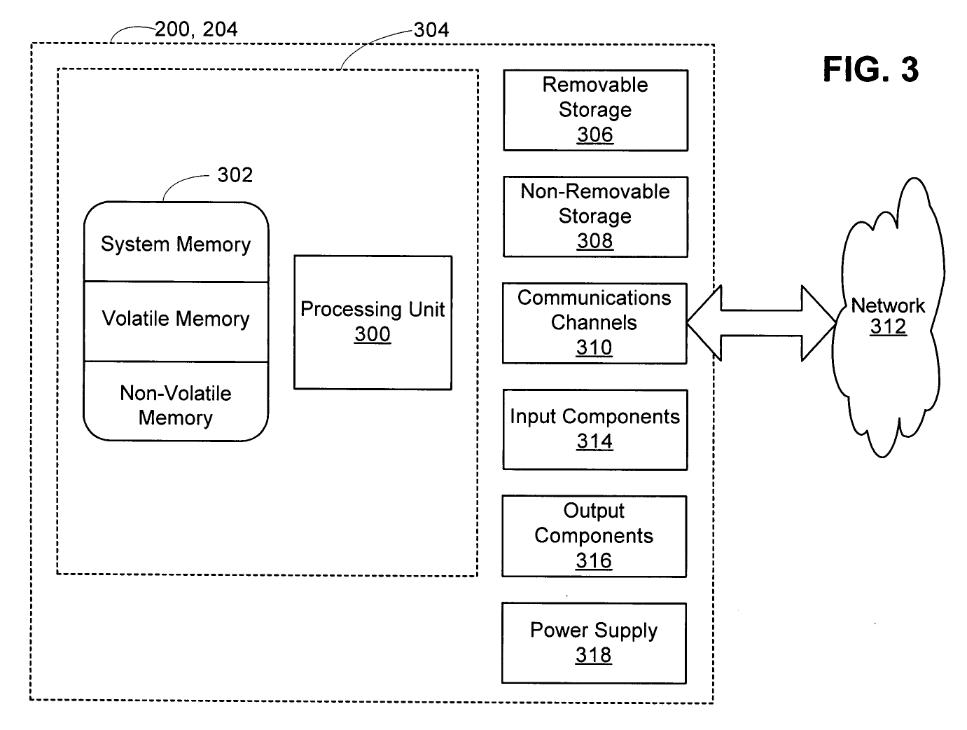

The model development machine 200 and the testing machines 204, 206, 208, and 210 of FIG. 2 may be of any architecture. FIG. 3 is a block diagram generally illustrating an exemplary computer system that supports the present invention. The computer system of FIG. 3 is only one example of a suitable environment and is not intended to suggest any limitation as to the scope of use or functionality of the invention. Neither should the model development machine 200 nor the testing machine 204 be interpreted as having any dependency or requirement relating to any one or combination of components illustrated in FIG. 3. The invention is operational with numerous other general-purpose or special-purpose computing environments or configurations. Examples of well known computing systems, environments, and configurations suitable for use with the invention include, but are not limited to, personal computers, servers, hand-held or laptop devices, multiprocessor systems, microprocessor-based systems, set-top boxes, programmable consumer electronics, network PCs, minicomputers, mainframe computers, and distributed computing environments that include any of the above systems or devices. In their most basic configurations, the model development machine 200 and the testing machine 204 typically include at least one processing unit 300 and memory 302. The memory 302 may be volatile (such as RAM), non-volatile (such as ROM or flash memory), or some combination of the two. This most basic configuration is illustrated in FIG. 3 by the dashed line 304. The model development machine 200 and the testing machine 204 may have additional features and functionality. For example, they may include additional storage (removable and non-removable) including, but not limited to, magnetic and optical disks and tape. Such additional storage is illustrated in FIG. 3 by removable storage 306 and by non-removable storage 308. Computer-storage media include volatile and non-volatile, removable and non-removable, media implemented in any method or technology for storage of information such as computer-readable instructions, data structures, program modules, or other data. Memory 302, removable storage 306, and non-removable storage 308 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the model development machine 200 or by the testing machine 204. Any such computer-storage media may be part of the model development machine 200 or of the testing machine 204. The model development machine 200 and the testing machine 204 may also contain communications channels 310 that allow them to communicate with other devices, including devices on a network 312. Communications channels 310 are examples of communications media. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include optical media, wired media, such as wired networks and direct-wired connections, and wireless media such as acoustic, RF, infrared, and other wireless media. The term “computer-readable media” as used herein includes both storage media and communications media. The model development machine 200 and the testing machine 204 may also have input devices 314 such as a touch-sensitive display screen, a hardware keyboard, a mouse, a voice-input device, etc. Output devices 316 include the devices themselves, such as the touch-sensitive display screen, speakers, and a printer, and rendering modules (often called “adapters”) for driving these devices. All these devices are well know in the art and need not be discussed at length here. The model development machine 200 and the testing machine 204 each has a power supply 318.

FIG. 4 depicts various model-based testing technologies and their interdependencies. Though most of the examples in this patent specification focus on the technologies along the bold path (including the finite state machine 400, model 402, test cases 412, hand-written test code 414, test execution runtime 416, tighter oracles 420, and test results 422), the first level of nodes emanating from the model node 402 show tools that can:
exploit a finite state machine runtime 400;
generate monkeys to randomly walk through the model (dynamic traversal 408);
drive code that uses either a production grammar or an evolving grammar 404 (to generate actual source-code programs); and
implement a high-level Petri net graph 406 (which, in turn, either generates a finite state machine 400 or acts like a monkey 408).

Once the model-based testing system generates test cases 412 (either the monkey's random walk 408 or a graph traversal 406 or some source code to test an application program interface), the test cases go either to test automation 416 or to a web site where humans can execute the tests manually 418. In both cases, the executed test results are sent to a data store for reporting and investigation 422. Investigation documents a product bug or produces information used to correct the model 402 or to tighten the model oracles 420 so further tests can find ever more subtle bugs.

In sum, the following technologies are used together to fully exploit a model-based testing infrastructure:
a source-code model;
a way to serialize the model-generated test cases (preferably to XML);
test automation (to run the serialized test cases);
a test execution runtime (to drive the system under test with the test automation); and
test oracles (to determine whether a test passed or failed).

The following example presents a simple finite state machine model in order to illustrate the detailed workings of an embodiment of the invention. The example models the Calculator program that ships with Microsoft's WINDOWS™ operating system. The code samples, written in the C# programming language, are intentionally kept short for the sake of clarity in the present discussion, but the reader is encouraged to consult the full source-code listings given in the Appendices. The Appendices form an integral part of this patent specification.

Finite state machines are the most popular models used in programming. Any code that implements a finite state machine needs four things:
a set of state variables and their possible values (hence the “finite” in finite state machine);
actions (or methods) that change the values of these state variables;
logic that dictates when one or more of these state-changing actions fire (that is to say, “occur”); and
a client that drives the state space generation.
   With these four components a finite state machine begins in an initial state and evolves to one or more subsequent states. Model-based testing uses the list of actions that transform the state space to drive tests of the modeled software package.

In this example, a state variable looks like any other public variable. The following listing shows the state variables for this model.

```
public struct StateVars
{
  public struct AppStatus
  {
    public const string NotRunning = “NotRunning”;
    public const string Running = “Running”;
  }
  public struct ViewStatus
  {
    public const string Standard = “Standard”;
    public const string Scientific = “Scientific”;
  }
  public struct DisplayStatus
  {
    public const string Empty = “Empty”;
    public const string Number = “Number”;
  }
}
public string AppStatus;
public string ViewStatus;
public string DisplayStatus;
```

The StateVars struct contains sub-structs that specify model action types and their range of values. For convenience, the public field names are taken from the StateVar sub-structs.

State-changing actions are nothing more than methods in C#. These methods tend to be very short and tend to change only one state variable. For example, StartCalc( ), the first method called (see the Main( ) method below), sets the AppStatus variable to a running state.

public void StartCalc( )
{
this.AppStatus = StateVars.AppStatus.Running;
}

Only when the model is “running” will the other state-changing actions be enabled and only when their own preconditions hold.

To know when to call a specific action, the model uses a method called GetEnabledActions( ) that returns a new ArrayList object. This ensures that only the actions currently enabled are present in the list. (Note that in other examples given below, GetEnabledActions( ) is replaced by the property EnabledActions.)

```
public ArrayList GetEnabledActions( )
{
  ArrayList enabledActions = new ArrayList( );
  // *** If the calculator is not running, then StartCalc is enabled.
  if(this.AppStatus == StateVars.AppStatus.NotRunning)
  {
    enabledActions.Add(“StartCalc”);
  }
  // *** If the calculator is running, then StopCalc is enabled.
  if(this.AppStatus == StateVars.AppStatus.Running)
  {
    enabledActions.Add(“StopCalc”);
  }
  ...
  return enabledActions;
}
```

This logic is very simple: Interrogate each state variable's value to see if it is in a condition that enables some action to fire. The method (see Main( ) below) that calls GetEnabledActions( ) iterates the list and uses a switch statement to dereference the method that actually changes the state variable's value (such as StartCalc( ) above).

The Main( ) method drives the model generation. At the heart of this method is a loop that iterates through the enabled actions list and uses a switch statement to call appropriate action methods.

```
static void Main( )
{
  ...
  foreach(string action in currentState.GetEnabledActions( ))
  {
    endState = currentState.Clone( );
    // Each action affects the end state of the transition.
    switch(action)
    {
      case “StartCalc”: endState.StartCalc( ); break;
      case “StopCalc”: endState.StopCalc( ); break;
      ...
      case “EnterNumber”: endState.EnterNumber( ); break;
    }
    ...
  }
  ...
}
```

The endState object is a clone of the currentState object (which is returning the actions currently enabled), so changing that state object may produce a new state object. Once the foreach( ) loop is done exploring the effects of all of the enabled actions on the current state (using the endState clones), it starts the process over for each new state discovered in the preceding passes.

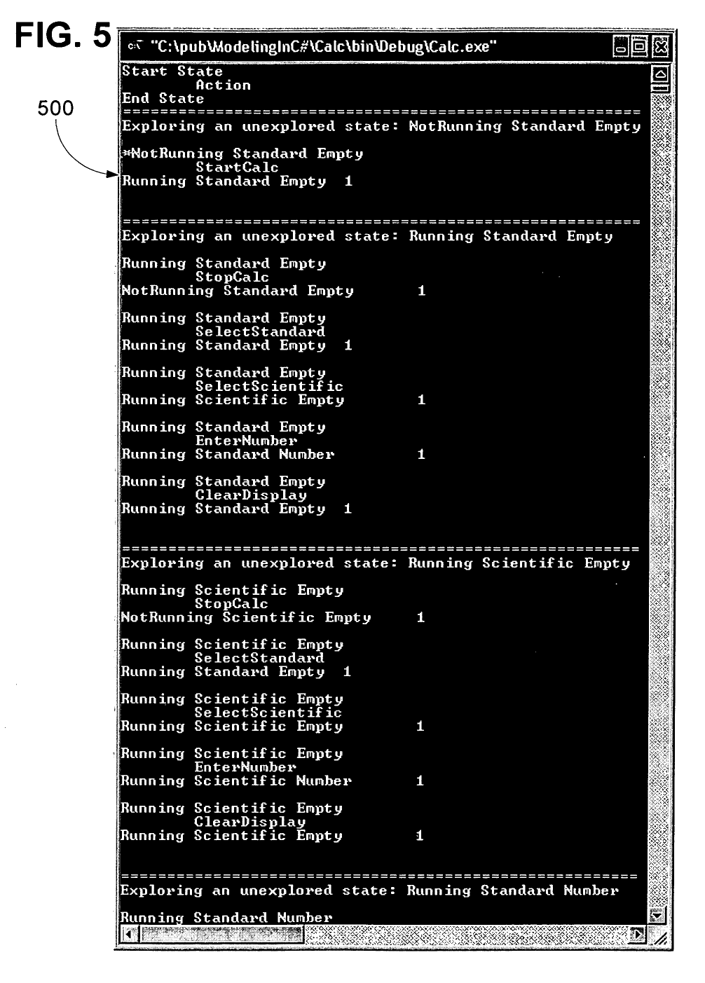

To see how the model evolves its state space, look at the state table output 500 in FIG. 5. FIG. 5 shows the model's initial condition and the only action enabled in that initial state, StartCalc. The model then changes its state to AppRunning. Five actions are enabled in the AppRunning state, and the model keeps track of each one exploring what actions are enabled in each and adding any new states to the set of unexplored states. Each group of state transformations in FIG. 5 begins with the first to the last new state in a preceding generation.

The above example demonstrates the feasibility of using source code alone (that is, without, in some embodiments, any binary augmentation) to create a model. The following discussion presents a Runtime environment that makes model-based testing easier, user-extensible, and more time efficient.

A first major feature of the Runtime environment is the encapsulation of the variability of model implementations. For example, every model has a unique collection of state variables. In simple models, like the first example above, Object base class operators and methods are overridden. The Calculator model's override of the ToString( ) method looks like this:

```
public override string ToString( )
{
  string s;
  s = this.AppStatus.ToString( ) + “”;
  s = s + this.ViewStatus.ToString( ) + “”;
  s = s + this.DisplayStatus.ToString( ) + “”;
  return(s);
}
```

Manually coding these overrides for each new model becomes increasingly prone to error as models get more complex. Forgetting to change one line in an override can cause very surreptitious bugs. The Runtime solves this problem by using .NET Reflection. The Runtime overrides ToString( ) as follows:

```
public override string ToString( )
{
  StringBuilder sb = new StringBuilder( );
  StateVariableAttribute stateVar;
  foreach(FieldInfo fieldInfo in modelFieldInfoArray)
  {
    stateVar = (StateVariableAttribute)Attribute.GetCustomAttribute(
      fieldInfo, typeof(StateVariableAttribute));
    if(stateVar != null)
    {
      sb.AppendFormat(“{0}={1}\n”,
      fieldInfo.Name,
      fieldInfo.GetValue(model));
    }
  }
  return sb.ToString( );
}
```

The trick is to be able to tell which variables in the model are state variables and which are control fields or properties. The Runtime differentiates these two kinds of variables with the [StateVariable] custom attribute. The enhanced Calc model (refactored to use the runtime) declares its state variables as follows:
[StateVariable]
private AppState App;
[StateVariable]
private ViewState View;
[StateVariable]
private DisplayState Display;
   The ToString( ) override iterates all of the fields in the model component and processes any field decorated with the [StateVariable] attribute. The Object overrides no longer need to be manipulated by hand. Thus the Runtime saves development time and eliminates the problem of a test engineer forgetting to change an override.

When the first example above is run, the output (500 of FIG. 5) includes a state table, but no test cases. The test engineer could add code to the model to write action names to a file and produce (at least) a sequence of test actions that the automation could take. However, having only a sequence of actions does not yield the intermediate state of the model. Without this state information the only way to tell if a test fails is to detect a crash of the software package being tested. The Runtime produces an XML file containing both a sequence of actions and a list of the (end) state variable values. With this information, the test automation takes the next action, compares the state of the tested system with the state variables holding end state values, and throws an exception when there is a discrepancy. (Because the discrepancy can be due to a bug in the software package being tested, to a bug in the model, or to a bug in the test automation (or to some combination of these three), some level of post-test investigation is necessary before it can be determined whether a bug has been found in the software package being tested.)

The Runtime provides a field that is assigned inside a model with a reference to a class file written to serialize test data to an XML schema. Code in the Runtime is called to serialize the state variable values, to list the actions taken for each test case, and finally to do any post-test case generation serialization. Once this serialization class is written, every model can reuse the code. If a model requires an XML schema different from one already provided, then a new schema can be plugged in without recompiling the modeling environment's class library. (In some embodiments, a serialization library would be recompiled whenever the serialization classes change.)

To exploit the power of graph theory in model-based testing, the test engineer can link his state space to a graph library to produce a state graph. Then, various graph-traversal algorithms can be used to generate test cases.

The following discussion puts several points made above into context by walking through some of the key steps in developing a finite state machine model according to the methods of the present invention.

Step 1: Decorate the model class with model and traversal metadata. Though the custom attributes appear at the top of the custom model classes, many test engineers do not fill them out first (most often these attributes are updated just before or after the first test cases are generated). However, a single ModelInfoAttribute is required else the Runtime will throw an exception.

The first two properties of the ModelInfo attribute are, in the parlance of .NET custom attributes, positional properties. This means that values must be provided for them in the order in which they appear.

```
[ModelInfo (
  “Goldilocks.Model.Calculator.dll”,
  “Models the Microsoft Calculator application.”,
  Contact=“mcorning”,
  DropLocation=@”C:\pub\Goldilocks\bin\Goldilocks.Model.Sample\
  drop”)
]
```

The first property tells the serialization class the name of a test automation dll (Dynamic Linked Library). The second property describes the model. Test-case serialization should include this descriptive text in the generated XML file. The DropLocation property tells the serialization class where to drop the generated files.

The TraversalInfo attribute is unlike the ModelInfo attribute in two ways. First, and not surprisingly, TraversalInfo uses different properties. Second, there can be more than one TraversalInfo attribute. In fact there can be as many as the number of traversals supported by the modeling environment. Here are three examples:

```
[TraversalInfo(GoldilocksTraversal.Random,
  MomLevel.Functionals,
  Description = “Random walk (100 actions).”,
  TestClass = “Microsoft.Test.Calculator”,
  Active = ActiveAttributeValue.True,
  MaxActionCount = 101)
]
[TraversalInfo(GoldilocksTraversal.AllStates,
  MomLevel.Functionals,
  Description = “Functional tests (AllStates)”,
  TestClass = “Microsoft.Test.Calculator”,
  Active = ActiveAttributeValue.False)
]
[TraversalInfo(GoldilocksTraversal.AllTransitions,
  MomLevel.Smokes,
  Description = “Smoke tests (AllTransitions)”,
  TestClass = “Microsoft.Test.Calculator”,
  Active = ActiveAttributeValue.True)
]
```

There is a positional property in the attribute that tells the client class which traversals to use. Note that there is one named property that will probably always be useful when traversing a state graph with a random walk: the number of steps to take in the traversal (which is not the same as the number of generated test cases, for each test case usually takes more than one step).

Step 2: Enumerate types for the model's state variables. In the first example above, state variable types are grouped in a single class. By segregating state variables, this makes them easier to select. But there is no requirement for this. For example, in the refactored Calculator model enums are used instead of strings, and they are not grouped into a class.

```
public enum AppState
{
  NotRunning = 1,
  Running = 2
}
public enum ViewState
{
  Standard,
  Scientific,
}
public enum DisplayState
{
  Hex,
  Dec,
  Oct,
  Bin
}
```

Step 3: Declare the model's enumerated state variables. Above it is shown how the Runtime identifies state variables. The Runtime does not care whether the model class uses private (recommended) or public state variables and can recognize both.

Step 4: Enumerate the possible Actions that the model can take. The simple Calculator model adds simple strings to the ArrayList of enabled actions. The Runtime can use an Action enum to list possible actions separately. Besides improving consistency, the Runtime can interrogate the Action enum at runtime to produce an interface file. When the test automation is written, an environment-generated interface is implemented to ensure that all of the current model actions are implemented in the automation.

Step 5: Define Action Methods that change state variable values. This step is illustrated above in the first example. Every state variable needs at least one action or method that will change its value.

Step 6: In the model's current state, find enabled actions. The only difference between the first example above and a Runtime-empowered version is that a property (instead of a method) is used that returns an ICollection object.

Step 7: Change model states (with Actions corresponding to enabled actions). In testing, the model code does not have to be fast and does not have to use the latest programming language innovations (though they should not be ignored, either). The primary goal is readability and reviewability. With this in mind, the Runtime has been implemented without using delegates. Instead, a public ChangeState( ) method maps action names to model methods. The interface mandates an object argument (so something other than an enum for the model's actions can be implemented) which is cast to the Action enum in the Calculator model.

```
public void ChangeState(object action)
{
  switch((Action)action)
  {
    case Action.EnterDecNumber:
      // Chose a number.
      this.EnterNumber(10);
      break;
    case Action.EnterNonDecNumber:
      // Chose a “number.”
      this.EnterNumber(“10”);
      break;
    default:
      throw new ArgumentException(
        “GoldilocksModel.ChangeState( ) does not yet ” +
        “implement enabled Action ” + action + “.”);
  }
}
```

All but two of the cases are removed to highlight an advantage of using a programming language like C# to implement models. The case clauses above call EnterNumber( ) methods with different signatures. This enables the use of two different methods that do rather different things, but that retain basically the same semantics.

```
public void EnterNumber(long number)
{
    if(this.Display == DisplayState.Dec)
    {
        this.Number = number;
    }
}
public void EnterNumber(string number)
{
    Debug.Assert(Display != DisplayState.Dec,
        “Cannot be in Dec format.”,
        “String numbers require the calculator to be in Scientific
        view ” + “using Bin, Hex, or Oct formats.”);
    int fromBase =
        (Display == DisplayState.Bin) ? 2 :
        (Display == DisplayState.Oct) ? 8 : 16;
    this.Number = Convert.ToInt64(number, fromBase);
}
```

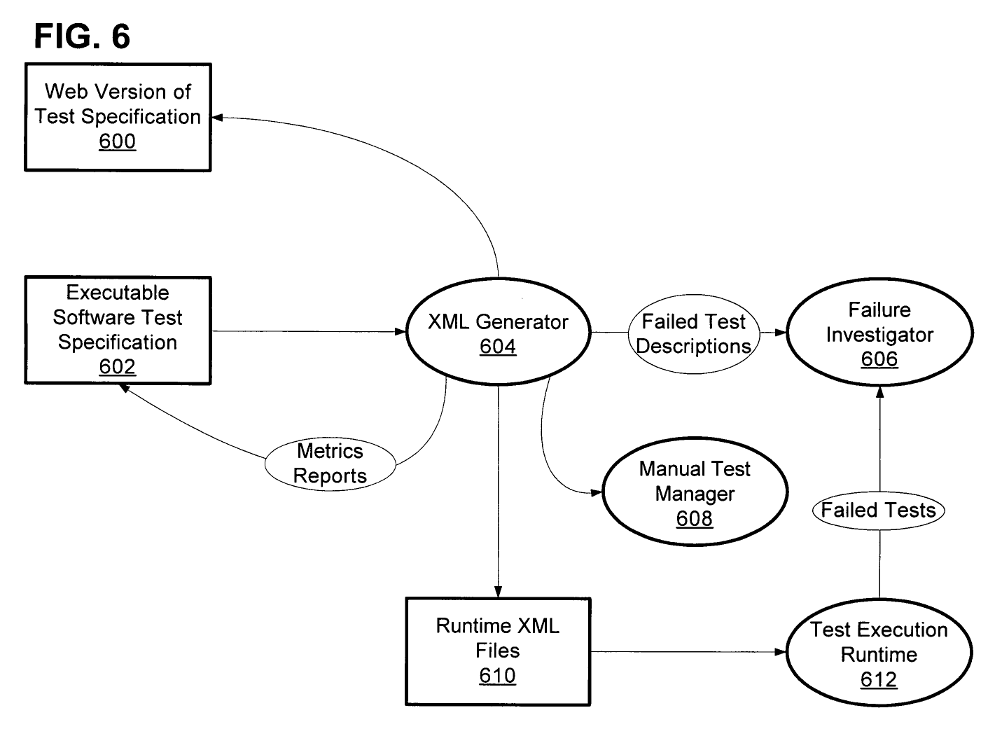

The above discussion highlights some of the advantages of modeling in a programming language instead of relying on a self-contained modeling tool. To recap with a different focus, FIG. 6 is a high level diagram showing how the major components of a test execution system interact. Two points to be noted from FIG. 6 are:
the Executable Software Test Specification 602 can be a model; and
XML makes it possible to refactor the model and its generated test cases into any shape necessary to get the testing job done.
   Having a model generate XML enables the model to morph into any shape necessary to execute tests and to log results. For example, the XML generator 604 can generate web pages 600 used to execute test cases manually as well as automate the execution of model-generated test cases 610.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details, such as coding choices, are determined by specific situations. Although the environment of the invention is described in terms of software modules or components, some processes may be equivalently performed by hardware components. Therefore, the invention as described herein contemplates all such embodiments as may come within the scope of the following claims and equivalents thereof.

APPENDIX A
Sample Calculator Code

```
using System;
using System.Collections;
using System.Diagnostics;
using System.Drawing;
using System.Reflection;
using Goldilocks.Core;
using Goldilocks.Core.Enums;
using Goldilocks.Core.Serialization;
using Goldilocks.Model.CustomAttributes;
using Goldilocks.Model.Constants;
using Goldilocks.Model.Serialization;
using Goldilocks.Core.QuickGraph;
#region Step 0: Overview of using Goldilocks to model software tests
  /*
  * When outling for this file is set to Collapse to Definitions you will see
  * several regions marked with “Step...”
  * Expand each of these steps on do what the region title indicates.
  * Be sure the project that contains your model is in the Goldilocks solution,
  * and when you build the solution Goldilocks will immediately process your model
  * and will prompt you to run one or more traversals against the model's state
  * graph to generate tests cases.
  * NOTE: to serialize your test cases, Goldilocks needs an implementation of the
  * ISerializeTestCases interface.
  */
#endregion
namespace Goldilocks.Model.Sample
{
  #region Step 1: Decorate this model class with model and traversal metadata.
  // Enter tester-defined model metadata (positional properties are required
  // to compile the model).
  [ModelInfo (
    “Goldilocks.Model.Calculator.dll”,
    “Models the Microsoft Calculator application.”,
    Contact=“mcorning”,
    DropLocation=@“C:\pub\Goldilocks\bin\Goldilocks.Model.Sample.Calc\drop”,
    StateGraphImgType=“svg”)
  ]
  /*
    * Use the following constants for arguments in TraversalInfoAttribute metadata:
    * GoldilocksTraversal
    * MomLevel
    * ActiveAttributeValue: True to include test cases at runtime, False to exclude.
    * NOTE TO TESTERS: if your test case serializer requires attributes,
    * make them positional instead of named; that way the compiler will catch
    * missing serialization attributes, on the other hand, named attributes
    * are a bit more human-friendly.
*/
/*
[TraversalInfo(GoldilocksTraversal.Random,
    MomLevel.Functionals,
    Description=“Random walk (100 actions).”,
    TestClass=“Microsoft.Test.Calculator”,
    Active=ActiveAttributeValue.True,
    MaxActionCount=101)
]
*/
[TraversalInfo(GoldilocksTraversal.AllStates,
    MomLevel.Functionals,
    Description=“Functional tests (AllStates)”,
    TestClass=“Microsoft.Test.Calculator”,
    Active=ActiveAttributeValue.False)
]
/*
[TraversalInfo(GoldilocksTraversal.AllTransitions,
    MomLevel.Smokes,
    Description=“Smoke tests (AllTransitions)”,
    TestClass=“Microsoft.Test.Calculator”,
    Active=ActiveAttributeValue.True)
]
*/
#endregion
public class Calculator : IGoldilocksModel
{
  #region Step 2: Enumerate types for this model's state variables.
  public enum AppState
  {
    NotRunning,
    Running
  }
  public enum ViewState
  {
    Standard,
    Scientific,
  }
  public enum DisplayState
  {
    Dec,
    Hex,
  Oct,
  Bin
}
#endregion
#region Step 3: Declare this model's enumerated state variables.
[StateVariable]
private AppState App;
[StateVariable]
private ViewState View;
[StateVariable]
private DisplayState Display;
[StateVariable]
private long Number;
#endregion
#region Step 4: Enumerate possible Actions this model can take.
/// <summary>
/// Enum simplifies coding and ensures one place listing all actions. If you forget
/// to implement one of these Actions, you'll throw a runtime exception that tells
/// you of the first missing enum in GoldilocksModel.ChangeState( ).
/// </summary>
public enum Action
{
  StartCalc,
  StopCalc,
  SelectStandard,
  SelectScientific,
  EnterNonDecNumber,
  EnterDecNumber,
  ClearDisplay,
  ClearDisplay2,
  DisplayDec,
  DisplayHex,
  DisplayOct,
  DisplayBin
}
#endregion
#region Step 5: Define Action Methods that change state variable values.
public void StartCalc( )
{
  this.App=AppState.Running;
}
public void StopCalc( )
  {
    this.App=AppState.NotRunning;
    this.EnterNumber(0);
  }
  public void SelectScientific( )
  {
    this.View=ViewState.Scientific;
  }
  public void SelectStandard( )
  {
    this.View=ViewState.Standard;
  }
  public void DisplayDec( )
  {
    this.Display=DisplayState.Dec;
  }
  public void DisplayHex( )
  {
    this.Display=DisplayState.Hex;
  }
  public void DisplayOct( )
  {
    this.Display=DisplayState.Oct;
  }
  public void DisplayBin( )
  {
    if(this.View==ViewState.Scientific)
    {
      this.Display=DisplayState.Bin;
    }
    else
    {
      throw new ArgumentException(“Need to be in Scientific view.”);
    }
}
public void EnterNumber(long number)
{
  if(this.Display==DisplayState.Dec)
  {
    this.Number = number;
  }
}
public void EnterNumber(string number)
{
  Debug.Assert(Display!=DisplayState.Dec,
    “Cannot be in Dec format.”,
    “String numbers require the calculator to be in Scientific view using Bin, Hex, or Oct
formats.”);
    int fromBase =
      (Display==DisplayState.Bin)?2:
      (Display==DisplayState.Oct)?8:16;
    this.Number = Convert.ToInt64(number, fromBase);
  }
  #endregion
  #region Step 6: In model's current state, find enabled actions.
  public ICollection EnabledActions
  {
    get
    {
      ArrayList enabledActions = new ArrayList( );
      // TODO: if the current state of the model includes an enum that
      //  enables an action, add the action to the ArrayList.
      //  ChangeState( ) will use these actions later to
      //  change the model's current state to some different end state.
      // NOTE: you can disable previously enabled actions merely by prepending
      //  this negation expression to the if clause: false &&.
      //  For example, to disable all non-decimal formats, use this
      //  transition rule:
      //  if (false && this.View==States.ScientificView)
      // *** if the calculator is not running, then StartCalc is enabled
      if (this.App==AppState.NotRunning)
      {
        enabledActions.Add(Action.StartCalc);
      }
      else
      {
        // *** if the calculator is running, then
        if (this.App==AppState.Running)
        {
        //StopCalc is enabled
        enabledActions.Add(Action.StopCalc);
        // SelectStandard is enabled
        enabledActions.Add(Action.SelectStandard);
        // SelectScientific is enabled
        enabledActions.Add(Action.SelectScientific);
        // *** either View can use Dec format
        // enabledActions.Add(Action.DisplayDec);
      }
      // In Standard or Scientific View, you can enter a Dec number
      if (this.Display==DisplayState.Dec)
      {
        enabledActions.Add(Action.EnterDecNumber);
        enabledActions.Add(Action.ClearDisplay);
      }
        // *** in Scientific View, then enter a non-Dec number
      else if (this.Display!=DisplayState.Dec)
      {
        enabledActions.Add(Action.EnterNonDecNumber);
        enabledActions.Add(Action.ClearDisplay2);
      }
      // *** only Scientific View can use non-Dec formats
      if (false && this.View==ViewState.Scientific)
      {
        enabledActions.Add(Action.DisplayHex);
        enabledActions.Add(Action.DisplayOct);
        enabledActions.Add(Action.DisplayBin);
      }
    } // end else app is running
    return enabledActions;
  }
}
#endregion
#region Step 7: Change model state (with Actions corresponding to enabled action(s)).
/// <summary>
///
/// </summary>
/// <value>1</value>
/// <param name=“action”></param>
public void ChangeState(object action)
{
  // TODO: Simply add a case to the switch that binds the Actions enum
  //  returned by EnabledActions property to the Action methods
  //  you defined above.
  // each action affects the end states of the transition
  switch((Action)action)
  {
    case Action.StartCalc: this.StartCalc( ); break;
    case Action.StopCalc: this.StopCalc( ); break;
    case Action.SelectStandard: this.SelectStandard( ); break;
    case Action.SelectScientific: this.SelectScientific( ); break;
    case Action.ClearDisplay: this.EnterNumber(0); break;
    case Action.ClearDisplay2: this.EnterNumber(“0”); break;
    case Action.DisplayBin: this.DisplayBin( ); break;
    case Action.DisplayDec: this.DisplayDec( ); break;
    case Action.DisplayHex: this.DisplayHex( ); break;
    case Action.DisplayOct: this.DisplayOct( ); break;
    case Action.EnterDecNumber:
      // chose a number
      this.EnterNumber(10);
      break;
    case Action.EnterNonDecNumber:
      // chose a “number”
      this.EnterNumber(“10”);
      break;
    default:
      throw new ArgumentException(“GoldilocksModel.ChangeState( ) does not yet “+
        ”implement enabled Action “+action+”.”);
  }
}
/// <summary>
/// Optional event handler to override default ordinal-based vertex names
/// </summary>
#endregion
#region Optional event handler class for overriding default vertex labels
public class VertexAppearanceHandler: IVertexAppearance
{
  public string VertexAppearance(object sender, VertexFormatEventArgs args)
  {
  string label=null;
  switch(args.VertexName)
  {
    case “S0”:
      label = “”;
      break;
    default:
      throw new ApplicationException(“Cannot understand ”+args.VertexName);
  }
  return label;
    }
  }
#endregion
#region Interfaces members -- no edits required
#region IGoldilocksModel Members
#region Private fields (no edits required)
private int seed = 0;
private Random random=new Random(unchecked((int)DateTime.Now.Ticks));
public int Seed
{
  get{return seed;}
}
private ISerializeTestCases testCaseSerializer= new SerializeVarmap( );
private IVertexAppearance vertexAppearance = null;//new VertexAppearanceHandler( );
#endregion
#region Public properties (no edits required)
/// <summary>
///
/// </summary>
public ISerializeTestCases TestCaseSerializer
{
  get{return this.testCaseSerializer;}
}
public IVertexAppearance VertexAppearance
{
  get
  {
    return this.vertexAppearance;
  }
}
void Goldilocks.Core.IGoldilocksModel.ChangeState(object action)
{
  this.ChangeState((Action)action);
}
#endregion
#endregion
#region ICloneable Members
public object Clone( )
{
      return this.MemberwiseClone( );
    }
    #endregion
    #endregion
  }
}
```

APPENDIX B
Sample Code for Generating a Finite State Machine

```
/*Start modeling here:
* You've created a new project and copied this template into the new project's
* class file. Here's what you need to do next:
* 1) Add References (as identified with each using statement below)
* 2) Decide on class name and use it and your namespace as the new name of the
*   default Class1.cs file
* 3) If necessary, change the namespace of this new class and change “Class1”
*   (class and constructor values below) to your new class name
* 4) Change the ModelInfo custom attribute property values or replace the whole
*   ModelInfo with your own list of properties by modifying
*   Goldilocks\src\Goldilocks.Model.CustomAttributes\ModelInfoAttribute.cs
* 5) Specify the model's State Variables and each variable's possible values
* 6) Enumerate your model's actions
* 7) Specify the transition rules that will change the model's state with each action
* 8) Map the action enums with the action methods that will change model state
* 9) Search for any other occurrence of “EnterYour” in this file and change accordingly
*/
using System;
using System.Collections;
using System.Diagnostics;
using System.Reflection;
using System.Xml;
using Goldilocks.Core; //..\bin\Goldilocks.Core\Goldilocks.Core.dll
using Goldilocks.Core.Enums;
//..\bin\Goldilocks.Model.CustomAttributes\Goldilocks.Core.Enums.dll
using Goldilocks.Core.Serialization;
//..\bin\Goldilocks.Core.Serialization\Goldilocks.Core.Serialization.dll
using Goldilocks.Model.Constants;
//..\bin\Goldilocks.Model.CustomAttributes\Goldilocks.Model.Constants.dll
using Goldilocks.Model.CustomAttributes;
//..\bin\Goldilocks.Model.CustomAttributes\Goldilocks.Model.CustomAttributes.dll
using Goldilocks.Model.Serialization;
//..\bin\Goldilocks.Model.Serialization\Goldilocks.Model.Serialization.dll
using Goldilocks.Core.QuickGraph;
namespace Goldilocks.Model.Sample
{
  /// <summary>
  /// CodeFsm is a Goldilocks model of how to use Goldilocks to make a Goldilocks model.
  /// </summary>
  [ModelInfo (
    “Goldilocks.Model.Sample.CodeFsm.dll”,
    “Models the Goldilocks CodeFsm.”,
    GroupContext=“”,
    Owner=“”,
    Contact=“”,
    DropLocation=@“C:\pub\Goldilocks\src\Goldilocks.Model.Sample.CodeFsm\drop”,
    StateGraphImgType=“png”)
]
/*
  [TraversalInfo(GoldilocksTraversal.Dynamic,
      MomLevel.Functionals,
      Description=“Functional tests (Dynamic)”,
      TestClass=“”,
      Active=ActiveAttributeValue.True)
  ]
[TraversalInfo(GoldilocksTraversal.AllTransitions,
    MomLevel.Functionals,
    Description=“Functional tests (AllTransitions)”,
    TestClass=“”,
    Active=ActiveAttributeValue.True)
]
    */
/*
  [TraversalInfo(GoldilocksTraversal.AllStates,
      MomLevel.Smokes,
      Description=“Smoke tests (AllStates)”,
      TestClass=“”,
      Active=ActiveAttributeValue.True)
  ]
  */
public class CodeFsm: IGoldilocksModel
{
  #region State data
  /// <summary>
  /// StateValues is a nested class that contains all the enum types
  /// that the state variables you will define will use.
  /// </summary>
  public class States
  {
    /// <summary>
    /// You must enumerate the model's Actions before you can define the model's
    /// transition rules.
    /// </summary>
    public enum ActionStatus
    {
      /// <summary>
      /// Default value that triggers EnumerateActions <see cref=“Action”/>.
      /// </summary>
      NoActionsDefined,
      /// <summary>
      /// Precondition to defining transition rules. Set by EnumerateActions
      /// <see cref=“Action”/>.
      /// </summary>
      ActionsDefined
    }
    /// <summary>
    /// Before you can serialize test cases you need a state graph to traverse.
    /// </summary>
    public enum StateGraphStatus
    {
      /// <summary>
      /// Default value that triggers GenerateStateGraph <see cref=“Action”/>.
      /// </summary>
      NoStateGraph,
      /// <summary>
      /// Precondition to serializing test cases. Set by GenerateStateGraph <see cref=“Action”/>.
      /// </summary>
      StateGraphReady
    }
    /// <summary>
    /// This type controls two sequential steps: defining state variable types, and
    /// declaring instances of those types.
    /// </summary>
    public enum StateVariableStatus
    {
      /// <summary>
      /// Default value that triggers SpecifyTypes <see cref=“Action”/>.
      /// </summary>
      NoStateVariables,
      /// <summary>
      /// Precondition to declaring state variable instances in model.
      /// Set by SpecifyTypes <see cref=“Action”/>.
      /// </summary>
      StateVariableTypesReady,
      /// <summary>
      /// Precondition to defining transition rules in model.
      /// Set by InstantiateVars <see cref=“Action”/>.
      /// </summary>
      StateVariableInstancesReady
    }
    /// <summary>
    /// Controls state of transition rules which define which <see cref=“Action”/>s
    /// can fire from any given state of the model.
    /// </summary>
    public enum TransitionStatus
    {
      /// <summary>
      /// Default value that triggers GenerateStateGraph <see cref=“Action”/>.
      /// </summary>
      NoTransitionsSpecified,
      /// <summary>
      /// Precondition to generating a state graph.
      /// </summary>
      TransitionRulesReady
    }
    /// <summary>
    /// Controls end of processing the CodeFsm model.
    /// </summary>
    public enum TraversalStatus
    {
      /// <summary>
      /// Default value that triggers SerializeTests <see cref=“Action”/>.
      /// </summary>
      NoTraversals,
      /// <summary>
      /// When the traversalStatus state variable is in this condition, the model halts
      /// because this state does not enable any <see cref=“Action”/>s.
      /// </summary>
      TraversalSerialized
    }
  }
  [StateVariable]
  private CodeFsm.States.ActionStatus actionStatus;
  [StateVariable]
  private CodeFsm.States.StateGraphStatus stateGraphStatus;
  [StateVariable]
  private CodeFsm.States.StateVariableStatus stateVariableStatus;
  [StateVariable]
  private CodeFsm.States.TransitionStatus transitionStatus;
  [StateVariable]
  private CodeFsm.States.TraversalStatus traversalStatus;
  #endregion
  /// <summary>
  /// Actions are enabled when their preconditions hold.
  /// Actions change state (see <see cref=“CodeFsm.ChangeState(object)”/>).
  /// </summary>
  public enum Action
  {
    /// <summary>
    /// A precondition to generate state graphs. Rules that enable Actions are based
    /// on the values of one or more state variable values
    /// (see <see cref=“CodeFsm.EnabledActions”/>).
    /// </summary>
    DefineTransitions,
    /// <summary>
    /// A precondition to defining transitions.
    /// </summary>
    EnumerateActions,
    /// <summary>
    /// A precondition to serializing test cases. Graph traversal algorithms cross the
    /// state graph generating a sequence of actions.
    /// </summary>
    GenerateStateGraph,
    /// <summary>
    /// Create memory variables of types defined in the States class.
    /// The values of one or more state variables enable Actions, and Actions, in turn,
    /// change state variable values.
    /// </summary>
    Instantiate Vars,
    /// <summary>
    /// Final action of the modeling process. Serialized test cases are sequences of
    /// actions consumed by a test harness to drive test automation to actually test some
    /// application or system.
    /// </summary>
    SerializeTests,
    /// <summary>
    /// Precondition to instantiating state variable values. Specifying state variable
    /// types makes it easier to assign (type) appropriate values.
    /// </summary>
    SpecifyTypes
  }
  /// <summary>
  /// The EnabledActions property is where you specify the model's
  /// transition rules. That is, you specify what state the model
  /// must be in before a given Action is enabled.
  /// The model simulator dereferences this property at each step
  /// of the model's state space evolution (from the initial condition
  /// through to the last possible state the model can be in).
  /// Each time the simulator dereferences this property, the simulator
  /// iterates through the ICollection returned by EnabledActions and
  /// passes each enabled action back to the model's <see cref=“ChangeState(object)”/>
  /// method where the actual state-changing code is called.
  /// </summary>
  /// <example><code>
  /// if(this.stateVariableStatus==States.StateVariableStatus.NoStateVariables)
  /// {
  /// enabledActions.Add(Action.SpecifyTypes);
  /// }
  ///</code></example>
  public ICollection EnabledActions
  {
    get
    {
      ArrayList enabledActions = new ArrayList( );
      if(this.stateVariableStatus==States.StateVariableStatus.NoStateVariables)
      {
        enabledActions.Add(Action.SpecifyTypes);
      }
      if(this.stateVariableStatus==States.StateVariableStatus.StateVariableTypesReady)
      {
        enabledActions.Add(Action.InstantiateVars);
      }
      if(this.actionStatus==States.ActionStatus.NoActionsDefined)
      {
        enabledActions.Add(Action.EnumerateActions);
      }
      if(this.stateVariableStatus==States.StateVariableStatus.StateVariableInstancesReady &&
        this.actionStatus==States.ActionStatus.ActionsDefined &&
        this.transitionStatus==States.TransitionStatus.TransitionRulesReady &&
        this.stateGraphStatus!=States.StateGraphStatus.StateGraphReady)
      {
        enabledActions.Add(Action.GenerateStateGraph);
      }
      if (this.stateGraphStatus==States.StateGraphStatus.StateGraphReady &&
        this.traversalStatus!=States.TraversalStatus.TraversalSerialized)
      {
        enabledActions.Add(Action.SerializeTests);
      }
      if(this.stateVariableStatus==States.StateVariableStatus.StateVariableInstancesReady &&
        this.actionStatus==States.ActionStatus.ActionsDefined &&
        this.transitionStatus!=States.TransitionStatus.TransitionRulesReady)
      {
        enabledActions.Add(Action.DefineTransitions);
      }
      return enabledActions;
    }
  }
  /// <summary>
  /// ChangeState is part of the IGoldilocksModel interface. This method can either
  /// dereference a method or can change a state variable directly. The passed-in Action
  /// determines which state variables get which action. Generally Actions change only
  /// one state variable, but this is not a constraint.
  /// </summary>
  /// <param name=“action”>ChangeState will cast the object parameter as an Action
enum.</param>
  /// <example><code>
  /// case Action.DefineTransitions:
  /// this.transitionStatus=States.TransitionStatus.TransitionRulesReady;
  /// break;
  /// </code></example>
  public void ChangeState(object action)
  {
    switch((Action)action)
    {
      case Action.DefineTransitions:
        this.transitionStatus=States.TransitionStatus.TransitionRulesReady;
        break;
      case Action.EnumerateActions:
        this.actionStatus=States.ActionStatus.ActionsDefined;
        break;
      case Action.GenerateStateGraph:
        this.stateGraphStatus=States.StateGraphStatus.StateGraphReady;
        break;
      case Action.InstantiateVars:
        this.stateVariableStatus=States.StateVariableStatus.StateVariableInstancesReady;
        break;
      case Action.SerializeTests:
        this.traversalStatus=States.TraversalStatus.TraversalSerialized;
        break;
      case Action.SpecifyTypes:
        this.stateVariableStatus=States.StateVariableStatus.StateVariableTypesReady;
        break;
      default:
        throw new ArgumentException(“ChangeState( ) cannot process Action, “+action+”.”);
    }
  }
  /// <summary>
  /// testCaseSerializer holds a reference to a custom xml serialization
  /// provider. Such a provider is generally written once and used by all
  /// models destined for the test execution runtime that can consume the
  /// serialized xml.
  /// </summary>
  private ISerializeTestCases testCaseSerializer = new SerializeVarmap( );
  private IVertexAppearance vertexAppearance = new VertexAppearanceHandler( );
  /// <summary>
  /// Optional event handler to override default ordinal-based vertex names
  /// </summary>
  public class VertexAppearanceHandler: IVertexAppearance
  {
    /// <summary>
    /// Override the default value for state nodes in the state graph. The default
    /// node values are the enumerated values of the state variables that changed
    /// with the incoming edges.
    /// </summary>
    /// <param name=“sender”></param>
    /// <param name=“args”></param>
    /// <returns></returns>
    public string VertexAppearance(object sender, VertexFormatEventArgs args )
    {
      string label=null;
      switch(args.VertexName)
      {
        case “S0”:
          label = “Start coding Goldilocks”;
          break;
        case “S1”:
          label = “Types ready”;
          break;
        case “S2”:
          label = “Actions entered”;
          break;
        case “S3”:
          label = “Ready for vars”;
          break;
        case “S4”:
          label = “Ready for rules”;
          break;
        case “S5”:
          label = “Transitions ready”;
          break;
        case “S6”:
          label = “Ready to generate tests”;
          break;
        case “S7”:
          label = “Test ready to run”;
          break;
        case “S8”:
          label = “Ready for Actions”;
          break;
        default:
          throw new ArgumentException(“VertexAppearance( ) cannot understand
”+args.VertexName);
      }
      return label;
    }
  }
  #region Model in this region needs no editing
  private int seed = 0;
  /// <summary>
  /// Random number generator seed. The generated random number can be used in the model's
constructor.
  /// </summary>
  public int Seed
  {
    get{return seed;}
  }
  /// <summary>
  /// A property specified in the ISerializeTestCases interface, the TestCaseSerializer
  /// gets its value from an instance of a class that serializes test cases to xml.
  /// </summary>
  public ISerializeTestCases TestCaseSerializer
  {
    get
    {
      return this.testCaseSerializer;
    }
    }
    /// <summary>
    /// See CodeFsm.VertexAppearanceHandler( ).
    /// </summary>
    public IVertexAppearance VertexAppearance
    {
      get
      {
        return this.vertexAppearance;
      }
    }
    #region ICloneable Members
    /// <summary>
    /// Used to create a new state object whose state values are subsequently changed by
    /// the <see cref=“CodeFsm.ChangeState(object)”/> method.
    /// </summary>
    /// <returns></returns>
    public object Clone( )
    {
      return this.MemberwiseClone( );
    }
    #endregion
    #endregion
  }
}
```

APPENDIX C
A Sample Grammar Model

```
using System;
namespace Goldilocks.Core.Grammars
  {
  /// <summary>
  /// Summary description for Goldilocks.
  /// </summary>
  public class Evolution
  {
    byte[ ] chromosome = null;
    string[ ] nonTerminals = new
      string[ ]{
          “expr”,
          “op”,
          “number”,
          “feature”
        };
    string[ ] terminals = new
      string[ ]{
          “SheepNearby”,
          “KnightsNearby”,
          “HealthLevel”,
          “TownsNearby”,
          “ForestsNearby”,
          “+”,
          “−”,
          “*”,
          “/”,
          “\hat{ }”
        };
    string[ ] expression = new
      string[ ]{
          “expr op expr”,
          “number”,
          “feature”,
          “(expr)”
        };
    string[ ] op = new
      string[ ]{
          “+”,
          “−”,
          “\hat{ }”
          “*”,
          “/)”
        };
    string[ ] feature = new
      string[ ]{
          “SheepNearby”,
          “KnightsNearby”,
          “HealthLevel”,
          “TownsNearby”,
          “ForestsNearby”
        };
  int gene=0;
  string currentNonTerminal=null;
  string[ ] programWords = null;
  int wordIndex=0;
  public string Program = “expr”;
  public Evolution(byte[ ] chromosome)
  {
    this.chromosome=chromosome;
    this.Evolve(this.Program);
  }
  void Evolve(string program)
  {
    /* TODO:
      * when the production rule yields (expr) the model needs to
      * reset the wordIndex (or start a new wordIndex2 field) and start from
      * the leftmost word in the parentheses evolving the sub grammar.
      * once the subgrammar is finished, it can return control to the model
      * which will then process the remaining words of the super grammar.
    */
    // split the evolving program
    this.Program= program;
    programWords=program.Split( );
    // ensure wordIndex doesn't get ahead of the number of generated words
    if(this.programWords.Length==1)
    {
      this.wordIndex=0;
    }
    if(this.wordIndex < this.programWords.Length)
    {
      bool programContainsNonTerminal=false;
      // get the current nonTerminal
      foreach(string nonT in nonTerminals)
      {
        if(this.programWords[this.wordIndex]==nonT)
        {
          currentNonTerminal=this.programWords[this.wordIndex];
          programContainsNonTerminal=true;
          break;
        }
      }
      if(programContainsNonTerminal==true)
      {
        // evolve program
        // get gene based on current non-terminal
        int rulesIndex=0;
        int geneValue = (int)this.chromosome[this.gene];
        switch(this.currentNonTerminal)
        {
          case “expr”:
            rulesIndex = geneValue % (int)this.expression.Length;
            this.programWords[this.wordIndex]= this.expression[rulesIndex];
            break;
          case “(expr)”:
            rulesIndex = geneValue % (int)this.expression.Length;
            this.programWords[this.wordIndex]= “(“+this.expression[rulesIndex]+”)”;
            break;
          case “op”:
            rulesIndex = geneValue % (int)this.op.Length;
            this.programWords[this.wordIndex]= this.op[rulesIndex];
            wordIndex++;
            break;
          case “number”:
            this.programWords[this.wordIndex]= geneValue.ToString( );
            wordIndex++;
            break;
          case “feature”:
            rulesIndex = geneValue % (int)this.feature.Length;
            this.programWords[this.wordIndex]= this.feature[rulesIndex];
            wordIndex++;
            break;
      }
          // increment the gene (circling the array, if necessary
          if(this.gene==this.chromosome.Length−1)
          {
            gene=0;
          }
          else
          {
            gene++;
          }
          // run another generation
          Evolve(String.Join(“ ”, this.programWords));
        }
      }
    }
  }
}
```

We claim:

1. A method for testing a software package, the method comprising:
providing a source-code model of at least some of the intended operations of the software package;
reading the source-code model;
compiling the source-code model into a compiled model;
running the compiled model to generate a state graph;
generating a plurality of test cases by traversing the state graph;
storing the plurality of generated test cases in a markup language; and
reading the stored markup language to run the generated test cases.

2. The method of claim 1 wherein providing a source-code model comprises:
providing rules of behavior of at least some of the intended operations of the software package.

3. The method of claim 1 wherein providing a source-code model comprises:
providing intended states of at least some of the intended operations of the software package; and
providing intended transitions between at least some of the intended states.

4. The method of claim 1 wherein the source-code model is written in C#.

5. The method of claim 1 wherein running the compiled model comprises:
running library functions not provided by the source-code model.

6. The method of claim 1 wherein the markup language is XML.

7. The method of claim 1 further comprising:
recording results of the test cases.

8. A computer-readable medium having computer-executable instructions for performing a method for testing a software package, the method comprising:
providing a source-code model of at least some of the intended operations of the software package;
reading the source-code model;
compiling the source-code model into a compiled model;
running the compiled model to generate a state graph;
generating a plurality of test cases by traversing the state graph;
storing the plurality of generated test cases in a markup language; and
reading the stored markup language to run the generated test cases.

9. A method for testing a software package, the method comprising:
providing a source-code model of at least some of the intended operations of the software package;
reading the source-code model;
compiling the source-code model into a compiled model;
running the compiled model to generate an instance of a grammar;
generating a plurality of test cases by invoking rules of the instance of a grammar;
storing the plurality of generated test cases in a markup language; and
reading the stored markup language to run the generated test cases.

10. The method of claim 9 wherein providing a source-code model comprises:
providing rules of behavior of at least some of the intended operations of the software package.

11. The method of claim 9 wherein the source-code model is written in C#.

12. The method of claim 9 wherein running the compiled model comprises:
running library functions not provided by the source-code model.

13. The method of claim 9 wherein the markup language is XML.

14. The method of claim 9 further comprising:
recording results of the test cases.

15. A computer-readable medium having computer-executable instructions for performing a method for testing a software package, the method comprising:
providing a source-code model of at least some of the intended operations of the software package;
reading the source-code model;
compiling the source-code model into a compiled model;
running the compiled model to generate an instance of a grammar;
generating a plurality of test cases by invoking rules of the instance of a grammar;
storing the plurality of generated test cases in a markup language; and
reading the stored markup language to run the generated test cases.

16. A system for testing a software package, the system comprising:
a source-code model of at least some of the intended operations of the software package;
a compiler for compiling the source-code model into a compiled model;
a state explorer for generating a state graph from the compiled model;
a traverser for generating a plurality of test cases by traversing the state graph;
a first data store for storing the plurality of generated test cases in a markup language; and
a test executor for reading the stored markup language and for running the generated test cases.

17. The system of claim 16 wherein the source-code model comprises rules of behavior of at least some of the intended operations of the software package.

18. The system of claim 16 wherein the source-code model comprises intended states of at least some of the intended operations of the software package and intended transitions between at least some of the intended states.

19. The system of claim 16 wherein the source-code model is written in C#.

20. The system of claim 16 further comprising:
library functions not provided by the source-code model.

21. The system of claim 16 wherein the markup language is XML.

22. The system of claim 16 further comprising:
a second data store for recording results of the test cases.

23. A system for testing a software package, the system comprising:
a source-code model of at least some of the intended operations of the software package;
a compiler for compiling the source-code model into a compiled model;
a rule processor for generating a plurality of test cases by invoking rules of a grammar;
a first data store for storing the plurality of generated test cases in a markup language; and
a test executor for reading the stored markup language and for running the generated test cases.

24. The system of claim 23 wherein the source-code model comprises rules of behavior of at least some of the intended operations of the software package.

25. The system of claim 23 wherein the source-code model is written in C#.

26. The system of claim 23 further comprising:
library functions not provided by the source-code model.

27. The system of claim 23 wherein the markup language is XML.

28. The system of claim 23 further comprising:
a second data store for recording results of the test cases.

29. A method for testing a software package, the method comprising:
providing a source-code model of at least some of the intended operations of the software package;
reading the source-code model;
compiling the source-code model into a compiled model;
initializing the compiled model into a current state;
randomly selecting one action from a set of actions enabled in the current state of the compiled model;
setting a new current state for the compiled model, the new current state based, at least in part, on the randomly selected action; and
executing the randomly selected action as a test against the software package.

30. The method of claim 29 wherein providing a source-code model comprises:
providing rules of behavior of at least some of the intended operations of the software package.

31. The method of claim 29 wherein providing a source-code model comprises:
providing intended states of at least some of the intended operations of the software package; and
providing intended transitions between at least some of the intended states.

32. The method of claim 29 wherein the source-code model is written in C#.

33. The method of claim 29 further comprising:
recording results of the test.

34. The method of claim 29 further comprising:
repeating the selecting, setting, and executing steps.

35. A computer-readable medium having computer-executable instructions for performing a method for testing a software package, the method comprising:
providing a source-code model of at least some of the intended operations of the software package;
reading the source-code model;
compiling the source-code model into a compiled model;
initializing the compiled model into a current state;
randomly selecting one action from a set of actions enabled in the current state of the compiled model;
setting a new current state for the compiled model, the new current state based, at least in part, on the randomly selected action; and
executing the randomly selected action as a test against the software package.

36. A system for testing a software package, the system comprising:
a source-code model of at least some of the intended operations of the software package;
a compiler for compiling the source-code model into a compiled model;
a state explorer for initializing the compiled model into a current state, for randomly selecting one action from a set of actions enabled in the current state of the compiled model, and for setting a new current state for the compiled model, the new current state based, at least in part, on the randomly selected action; and
a test executor for executing the randomly selected action as a test against the software package.

37. The system of claim 36 wherein the source-code model comprises rules of behavior of at least some of the intended operations of the software package.

38. The system of claim 36 wherein the source-code model is written in C#.

39. The system of claim 36 further comprising:
library functions not provided by the source-code model.

40. The system of claim 36 further comprising:
a data store for recording results of the test.
